(19) United States
(12) Patent Application Publication
(10) Pub. No.: US 2024/0123713 A1
(43) Pub. Date: Apr. 18, 2024

(54) POLYOLEFIN FILM FOR ALUMINUM PLASTIC FILM AND ALUMINUM PLASTIC FILM STRUCTURE

(71) Applicant: NAN YA PLASTICS CORPORATION, Taipei (TW)

(72) Inventors: TE-CHAO LIAO, TAIPEI (TW); CHING-YAO YUAN, TAIPEI (TW); Chih-Feng Wang, TAIPEI (TW)

(21) Appl. No.: 18/072,627

(22) Filed: Nov. 30, 2022

(30) Foreign Application Priority Data
Oct. 14, 2022 (TW) 111138968

(51) Int. Cl. B32B 27/08; B32B 15/082; B32B 15/20; B32B 27/32; C08L 23/12; C08L 23/16

(52) U.S. Cl. CPC B32B 27/08; B32B 15/082; B32B 15/20; B32B 27/32; C08L 23/12; C08L 23/16; B32B 2250/03; B32B 2307/31; C08L 2203/162

(57) ABSTRACT

A polyolefin film for an aluminum plastic film and an aluminum plastic film structure are provided. The polyolefin film includes a laminating film, a middle film, and a heat-sealed film. The middle film is disposed between the laminating film and the heat-sealed film. A lamination temperature of the laminating film ranges from 70° C. to 100° C. A material forming the laminating film is a first polyolefin material. The first polyolefin material has a modified group, and a structure of the modified group contains maleic anhydride. A material forming the middle film includes: 50 phr to 90 phr of a propylene block copolymer, 5 phr to 30 phr of an ethylene elastomer, and 5 phr to 20 phr of a propylene random copolymer.

### CROSS-REFERENCE TO RELATED PATENT APPLICATION

This application claims the benefit of priority to Taiwan Patent Application No. 111138968, filed on Oct. 14, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyolefin film and an aluminum plastic film structure, and more particularly to a polyolefin film and an aluminum plastic film structure applicable to packaging materials of vehicle lithium batteries.

### BACKGROUND OF THE DISCLOSURE

An aluminum plastic film is an important material for manufacturing a pouch cell. The aluminum plastic film is wrapped around a battery cell and an electrolyte to protect the content of a battery. The aluminum plastic film needs to be in contact with the electrolyte for a long time, and thus is required to have good resistance to the electrolyte. In addition, the aluminum plastic film also needs to achieve a packaging effect.

The structure of the aluminum plastic film includes an inner layer, an outer layer, and an aluminum foil layer located therebetween. The inner layer is located on an inner side of the aluminum plastic film for being in contact with the electrolyte, and can be used for packaging. The outer layer is located on an outer side of the aluminum plastic film for being in contact with outside air.

Conventionally, each of the inner layer and the outer layer can be disposed on the aluminum foil layer through an adhesive layer, so as to form an aluminum plastic film bonded by an adhesive. However, a manufacturing method of the adhesive-bonded aluminum plastic film is complex, which is not conducive to cost reduction. As a result, an aluminum plastic film in which the inner layer, the aluminum foil layer, and the outer layer are bonded via a thermal compounding process has been developed in the related art, so as to avoid the use of adhesive layers. However, in an electrolyte environment, an adhesive strength of this thermal-compounded aluminum plastic film decreases to less than 10 N/15 mm over time, which is unfavorable for application in the pouch cell.

Therefore, how to enhance an electrolyte-resistant adhesive strength of the aluminum plastic film through an improvement in the structure and composition has become one of the important issues to be solved in this industry.

### SUMMARY OF THE DISCLOSURE

In response to the above-referenced technical inadequacies, the present disclosure provides a polyolefin film for an aluminum plastic film and an aluminum plastic film structure.

In one aspect, the present disclosure provides a polyolefin film for an aluminum plastic film. The polyolefin film includes a laminating film, a middle film, and a heat-sealed film A material forming the laminating film is a first polyolefin material, the first polyolefin material has a modified group, and a structure of the modified group contains maleic anhydride. A lamination temperature of the laminating film ranges from 70° C. to 100° C. The middle film is disposed on the laminating film. A material forming the middle film includes: 50 phr to 90 phr of a propylene block copolymer, 5 phr to 30 phr of an ethylene elastomer, and 5 phr to 20 phr of a propylene random copolymer. The heat-sealed film is disposed on the middle film.

In some embodiments, an acid value of the first polyolefin material ranges from 0.1 mgKOH/g to 10 mgKOH/g.

In some embodiments, the modified group is formed from maleic anhydride, methyltetrahydrophthalic anhydride, 3,4,5,6-tetrahydrophthalic anhydride, tetrahydrophthalic anhydride, methylhexahydrophthalic anhydride, methyl nadic anhydride or 2,3-naphthalenedicarboxylic anhydride.

In some embodiments, the first polyolefin material is a random copolymer polymerized from a propylene monomer. Based on a total weight of the first polyolefin material being 100 wt %, a proportion of the propylene monomer is greater than 50 wt %. In some embodiments, the first polyolefin material is a random copolymer polymerized from an ethylene monomer, a propylene monomer, and a butylene monomer.

In some embodiments, a weight average molecular weight of the first polyolefin material ranges from 100,000 g/mol to 200,000 g/mol.

In some embodiments, the material forming the middle film has a melt index of from 0.5 g/10 min to 10 g/10 min when measured under conditions of 230° C. and a load of 2.16 kg.

In some embodiments, based on a total weight of the propylene block copolymer being 100 wt %, a content of ethylene-propylene rubber blocks in the propylene block copolymer ranges from 18 wt % to 30 wt %.

In some embodiments, based on a total weight of the ethylene elastomer being 100 wt %, a content of ethylene in the ethylene elastomer ranges from 30 wt % to 50 wt %.

In some embodiments, the ethylene elastomer is an ethylene/propylene elastomer, an ethylene/butylene elastomer or an ethylene/octylene elastomer.

In some embodiments, the propylene random copolymer is polymerized from a propylene monomer. Based on a total weight of the propylene random copolymer being 100 wt %, a proportion of the propylene monomer is greater than 50 wt %.

In some embodiments, a material forming the heat-sealed film is a second polyolefin material, and the second polyolefin material includes a random copolymer polymerized from an ethylene monomer and a propylene monomer. Based on a total weight of the random copolymer in the second polyolefin material being 100 wt %, a proportion of the ethylene monomer ranges from 0.2 wt % to 2 wt %.

In some embodiments, the second polyolefin material may further include a propylene homopolymer, and an added amount of the propylene homopolymer ranges from 5 phr to 20 phr relative to 100 phr of the second polyolefin material.

In some embodiments, the second polyolefin material has a melt index of from 3 g/10 min to 10 g/10 min when measured under conditions of 230° C. and a load of 2.16 kg.

In some embodiments, the laminating film, the middle film, and the heat-sealed film are integrally formed by co-extrusion.

In some embodiments, based on a total thickness of the polyolefin film being 100%, a thickness of the laminating film ranges from 10% to 15%, a thickness of the middle film ranges from 75% to 80%, and a thickness of the heat-sealed film ranges from 10% to 15%.

In another aspect, the present disclosure provides an aluminum plastic film structure. The aluminum plastic film structure includes an aluminum foil, a polyolefin film, and an outer film. The polyolefin film includes a laminating film, a middle film, and a heat-sealed film A material forming the laminating film is a first polyolefin material, the first polyolefin material has a modified group, and a structure of the modified group contains maleic anhydride. A lamination temperature of the laminating film ranges from 70° C. to 100° C. The middle film is disposed on the laminating film. A material forming the middle film includes: 50 phr to 90 phr of a propylene block copolymer, 5 phr to 30 phr of an ethylene elastomer, and 5 phr to 20 phr of a propylene random copolymer. The heat-sealed film is disposed on the middle film. The polyolefin film is disposed on one surface of the aluminum foil through the laminating film. The outer film is disposed on another surface of the aluminum foil. An electrolyte-resistant adhesive strength between the aluminum foil and the polyolefin film is greater than 14 N/15 mm After immersion in an electrolyte at 85° C. for 24 hours, the electrolyte-resistant adhesive strength between the polyolefin film and the aluminum foil is greater than 11 N/15 mm.

Therefore, in the polyolefin film for the aluminum plastic film and the aluminum plastic film structure provided by the present disclosure, by virtue of “the first polyolefin material having a modified group, and a structure of the modified group containing maleic anhydride” and “a material forming the middle film including: 50 phr to 90 phr of a propylene block copolymer, 5 phr to 30 phr of an ethylene elastomer, and 5 phr to 20 phr of a propylene random copolymer,” an electrolyte-resistant adhesive strength of the aluminum plastic film can be improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic side view of an aluminum plastic film structure according to the present disclosure;

FIG. 2 is a schematic side view of a polyolefin film for an aluminum plastic film according to the present disclosure; and

FIG. 3 is a flowchart showing steps from a method for manufacturing the polyolefin film for the aluminum plastic film according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure provides a polyolefin film and an aluminum plastic film manufactured from the polyolefin film. The polyolefin film of the present disclosure is located on an inner side of the aluminum plastic film, can be bonded to an aluminum foil by thermal lamination, and has a good adhesive strength.

Referring to FIG. 1, the aluminum plastic film for a lithium battery in the present disclosure includes an aluminum foil 1, a polyolefin film 2, and an outer film 3.

The aluminum foil 1 is disposed between the polyolefin film 2 and the outer film 3. An anti-corrosion treatment can be performed on two opposite surfaces of the aluminum foil 1 for respective formation of an anti-corrosion treatment layer. In this way, an effect of protecting the aluminum foil 1 can be achieved.

The polyolefin film 2 can be disposed on one surface of the aluminum foil 1 by thermal lamination. The polyolefin film 2 serves as an inner surface of the aluminum plastic film, and is in contact with an electrolyte after packaging. Through a selection of materials, the polyolefin film 2 in the present disclosure can be thermally laminated on the aluminum foil 1 at a low processing temperature (from 70° C. to 100° C.). Therefore, energy consumption in a manufacturing process of the aluminum plastic film can be reduced, and properties of other layer bodies can avoid being affected during processing.

The outer film 3 can be disposed on another surface of the aluminum foil 1 by lamination or adhesion, and serves as an outer surface of the aluminum plastic film to be in contact with outside air after packaging. The outer film 3 may be a nylon layer or a polyester layer. However, the present disclosure is not limited thereto.

The aluminum plastic film of the present disclosure is mainly applied to the lithium battery. As such, whether or not the aluminum plastic film has a good electrolyte-resistant adhesive strength needs to be taken into special consideration. After the aluminum plastic film is packaged, it is the inner surface formed by the polyolefin film 2 that is in actual contact with an electrolyte. Therefore, the electrolyte-resistant adhesive strength of the polyolefin film 2 is an important evaluation characteristic.

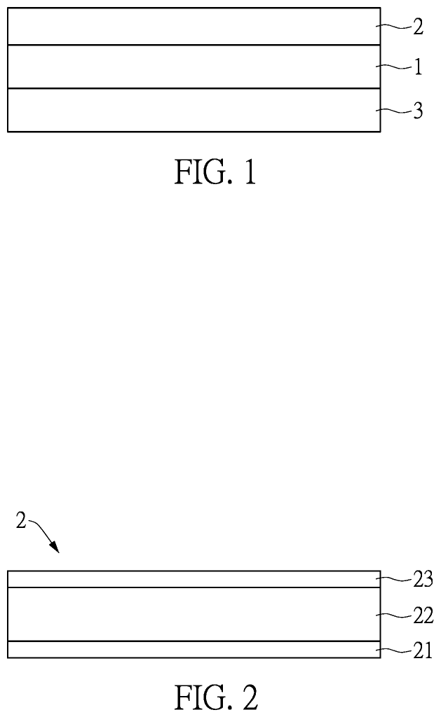

Referring to FIG. 2, the polyolefin film 2 in the present disclosure includes a laminating film 21, a middle film 22, and a heat-sealed film 23. A lamination temperature of the laminating film 21 ranges from 70° C. to 100° C. The polyolefin film 2 can be bonded to the aluminum foil 1 via the laminating film 21 by way of thermal lamination. The middle film 22 is disposed between the laminating film 21 and the heat-sealed film 23 for supporting and bonding the laminating film 21 and the heat-sealed film 23. A heat sealing temperature of the heat-sealed film 23 ranges from 170° C. to 200° C. Through the heat-sealed film 23, the polyolefin film 2 can be used for packaging, so as to manufacture a pouch cell.

In one exemplary embodiment, the polyolefin film 2 in the present disclosure is manufactured by co-extrusion. That is, the laminating film 21, the middle film 22, and the heat-sealed film 23 are integrally formed. In this way, the polyolefin film 2 in the present disclosure also has the advantage of being manufactured in a convenient manner.

In one exemplary embodiment, based on a total thickness of the polyolefin film 2 being 100%, a thickness of the laminating film 21 ranges from 10% to 15%, a thickness of the middle film 22 ranges from 75% to 80%, and a thickness of the heat-sealed film 23 ranges from 10% to 15%. In this way, a balance can be achieved between the electrolyte-resistant adhesive strength and manufacturing costs of the aluminum plastic film.

In the present disclosure, properties of the polyolefin film can be improved by adjustment of components, so that the polyolefin film can have a good electrolyte-resistant adhesive strength, and can still have a good electrolyte-resistant adhesive strength even after being exposed in a high temperature environment for a long time.

A material forming the laminating film 21 is a first polyolefin material, and the first polyolefin material has a modified group. The modified group may reduce a melting point of the first polyolefin material. In this way, an operation temperature at which the laminating film 21 is laminated to the aluminum foil 1 can be reduced. After the processing temperature is reduced, the physical properties of other layer bodies (e.g., the middle film 22 and the heat-sealed film 23 mentioned above) can be prevented from being changed during the lamination. In one exemplary embodiment, the melting point of the first polyolefin material ranges from 70° C. to 100° C. Preferably, the melting point of the first polyolefin material ranges from 85° C. to 95° C.

The modified group is grafted to a backbone or a branch of the first polyolefin material. In one exemplary embodiment, the modified group is formed from maleic anhydride or a maleic anhydride derivative (a compound in which its structure contains maleic anhydride). Therefore, the structure of the modified group contains the maleic anhydride. Specifically, through grafting, the modified group may be formed from maleic anhydride, methyltetrahydrophthalic anhydride, 3,4,5,6-tetrahydrophthalic anhydride, tetrahydrophthalic anhydride, methylhexahydrophthalic anhydride, methyl nadic anhydride or 2,3-naphthalenedicarboxylic anhydride.

In the present disclosure, an amount of the modified group in the first polyolefin material is quantified by testing of an acid value, so as to achieve an effect of appropriately reducing the melting point of the first polyolefin material. In one exemplary embodiment, the acid value of the first polyolefin material ranges from 0.1 mgKOH/g to 10 mgKOH/g. Preferably, the acid value of the first polyolefin material ranges from 3 mgKOH/g to 10 mgKOH/g.

In addition, an effect of balancing the processability and the electrolyte-resistant adhesive strength can be achieved by controlling a molecular weight of the first polyolefin material. A weight average molecular weight of the first polyolefin material ranges from 100,000 g/mol to 200,000 g/mol. When the weight average molecular weight of the first polyolefin material is greater than 200,000 g/mol, a viscosity of the first polyolefin material can be too high and adversely affect the processability. When the weight average molecular weight of the first polyolefin material is less than 100,000 g/mol, a bonding effect between the laminating film 21 and the aluminum foil 1 can be adversely affected.

In one exemplary embodiment, the first polyolefin material is a random copolymer polymerized from a propylene monomer and other monomers. In one exemplary embodiment, the first polyolefin material is polymerized from an ethylene monomer, a propylene monomer and a butylene monomer. Based on a total weight of the first polyolefin material being 100 wt %, a proportion of the propylene monomer is greater than 50 wt %.

A material forming the middle film 22 includes: 50 phr to 90 phr of a propylene block copolymer, 5 phr to 30 phr of an ethylene elastomer, and 5 phr to 20 phr of a propylene random copolymer. Through a selection of materials, the middle film 22 can have good conformability, and phase separation and film breaking are not likely to occur during processing. After processing, the middle film 22 may keep a smooth surface, and has good bonding with the laminating film 21 and the heat-sealed film 23.

The propylene block copolymer contains ethylene-propylene rubber blocks, and the ethylene-propylene rubber blocks can improve an impact strength of the middle film 22, thereby improving the conformability of the aluminum plastic film. However, since an improvement effect that can be achieved by the ethylene-propylene rubber blocks is limited, the ethylene elastomer is further added to the material forming the middle film 22. The addition of the ethylene elastomer can improve the impact strength of the middle film 22 and improve the conformability of the aluminum plastic film By controlling a content of ethylene in the ethylene elastomer, phase separation between the components (e.g., the propylene block copolymer, the ethylene elastomer, and the propylene random copolymer) can also be prevented, so that the middle film 22 can maintain a smooth surface. In addition, the addition of the propylene random copolymer can improve the bonding effect between the middle film 22 and the laminating film 21 and the heat-sealed film 23.

In one exemplary embodiment, based on a total weight of the propylene block copolymer being 100 wt %, a content of the ethylene-propylene rubber blocks in the propylene block copolymer ranges from 30 wt % to 50 wt %.

In one exemplary embodiment, based on a total weight of the ethylene elastomer being 100 wt %, the content of ethylene in the ethylene elastomer ranges from 30 wt % to 50 wt %. Specifically, the ethylene elastomer can be an ethylene/propylene elastomer, an ethylene/butylene elastomer or an ethylene/octylene elastomer.

In one exemplary embodiment, the propylene random copolymer is polymerized from a propylene monomer. Based on a total weight of the propylene random copolymer being 100 wt %, a proportion of the propylene monomer is greater than 50 wt %. Specifically, the propylene random copolymer is a random copolymer polymerized from an ethylene monomer, a propylene monomer, and a butylene monomer.

In addition, the material forming the middle film 22 may further include 100 ppm to 5000 ppm of a slip agent. The slip agent will migrate into the inner surface of the aluminum plastic film during processing, such that a smooth surface can be maintained for easy demolding. Further, the conformability and processability of the aluminum plastic film can be improved.

In one exemplary embodiment, a melt index of the material forming the middle film 22 ranges from 0.5 g/10 min to 10 g/10 min. Preferably, the melt index of the middle film 22 ranges from 1 g/10 min to 3 g/10 min. The melt index of the material forming the middle film 22 is measured under conditions of a temperature of 230° C. and a load of 2.16 kg.

A material forming the heat-sealed film 23 is a second polyolefin material. The second polyolefin material includes a random copolymer polymerized from an ethylene monomer and a propylene monomer. Based on a total weight of the random copolymer in the second polyolefin material being 100 wt %, a proportion of the ethylene monomer ranges from 0.2 wt % to 2 wt %, and a proportion of the propylene monomer ranges from 98 wt % to 98.8 wt %.

The material forming the heat-sealed film 23 contains a large amount of the propylene monomer, thereby providing a good bonding force with the middle film 22. A small amount of the ethylene monomer is blended in the material forming the heat-sealed film 23, so that crystallinity of the second polyolefin material can be reduced, and a melting point of the second polyolefin material can be reduced. Therefore, the heat-sealed film 23 has a heat sealing temperature of from 170° C. to 200° C., so that the aluminum plastic film has the advantage of high processability.

In one exemplary embodiment, the second polyolefin material may further include a propylene homopolymer. The addition of the propylene homopolymer can improve the heat sealing strength of the heat-sealed film 23. An added amount of the propylene homopolymer ranges from 5 phr to 20 phr relative to 100 phr of the second polyolefin material.

In one exemplary embodiment, a melt index of the second polyolefin material ranges from 1 g/10 min to 10 g/10 min. Preferably, the melt index of the second polyolefin material ranges from 3 g/10 min to 7 g/10 min. The melt index of the second polyolefin material is measured under conditions of a temperature of 230° C. and a load of 2.16 kg.

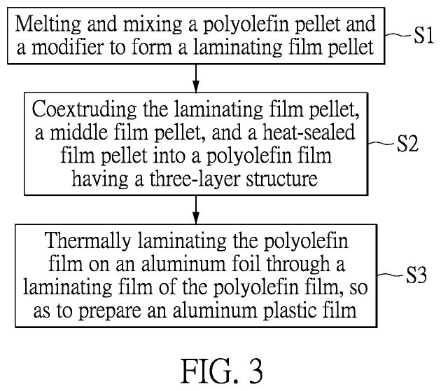

Referring to FIG. 3, a method for manufacturing the aluminum plastic film in the present disclosure includes: melting and mixing a polyolefin pellet and a modifier to form a laminating film pellet (step S1); coextruding the laminating film pellet, a middle film pellet, and a heat-sealed film pellet into a polyolefin film having a three-layer structure (step S2); and thermally laminating the polyolefin film on an aluminum foil through a laminating film of the polyolefin film, so as to prepare the aluminum plastic film (step S3).

In step S1, the polyolefin pellet and the modifier are melted and mixed at a temperature of from 160° C. to 210° C. In the mixing process, the polyolefin pellet react with the modifier, the modifier is grafted to a propylene random copolymer, and the above-mentioned modified polyolefin polymer is formed. The laminating film pellet is then prepared through extrusion by an extruder.

In one exemplary embodiment, the material of the polyolefin pellet is the propylene random copolymer. The modifier is selected from the group consisting of maleic anhydride, methyltetrahydrophthalic anhydride, 3,4,5,6-tetrahydrophthalic anhydride, tetrahydrophthalic anhydride, methylhexahydrophthalic anhydride, methyl nadic anhydride, and 2,3-naphthalenedicarboxylic anhydride. An added amount of the modifier ranges from 0.5 phr to 5 phr relative to the polyolefin pellet being 100 phr. It should be noted that a specific grafting amount of the modified group is quantified based on an acid value, and the added amount of the modifier is only provided for ease of description of the operation steps.

In step S2, the laminating film pellet, the middle film pellet, and the heat-sealed film pellet are each fed into a co-extrusion apparatus, and are coextruded into the polyolefin film that includes the laminating film, a middle film, and a heat-sealed film at a temperature of from 200° C. to 250° C. Specifically, the laminating film is formed from the laminating film pellet. Components of the laminating film pellet include the first polyolefin material as described above. The middle film is formed from the middle film pellet. Components of the middle film pellet include the propylene block copolymer, the ethylene elastomer, the propylene random copolymer, and the slip agent as described above. The heat-sealed film is formed from the heat-sealed film pellet. Components of the heat-sealed film pellet include the second polyolefin material as described above.

In step S3, the polyolefin film is laminated on the aluminum foil at a temperature of from 70° C. to 100° C., and an outer film is disposed on another surface of the aluminum foil. Alternatively, the outer film may be first disposed on another surface of the aluminum foil, and then the polyolefin film is laminated on the aluminum foil.

To verify that the polyolefin film and an aluminum plastic film structure in the present disclosure have a good electrolyte-resistant adhesive strength, aluminum plastic films in Examples 1 to 3 and Comparative Example 1 are prepared according to the foregoing steps S1 to S3. According to the contents and properties of the components listed in Table 1, an integrally formed polyolefin film (the laminating film, the middle film, and the heat-sealed film) is formed through co-extrusion.

### Examples 1 to 3

An aluminum foil having a thickness of 40 μm is selected as an aluminum foil layer. A polyolefin pellet made from a propylene random copolymer is selected. The polyolefin pellet and a modifier are melted and mixed at a temperature of 200° C., and are prepared into a laminating film pellet by an extruder.

The laminating film pellet, a middle film pellet, and a heat-sealed film pellet are used, and are coextruded into a polyolefin film that includes a laminating film, a middle film, and a heat-sealed film at a temperature of from 200° C. to 250° C. The polyolefin film is thermally laminated to the aluminum foil layer through the laminating film of the polyolefin film at a temperature of from 70° C. to 100° C.

A polyester adhesive is applied onto another surface of the aluminum foil layer, and a polyester layer having a thickness of 25 μm is placed on the polyester adhesive to serve as an outer film. After drying at a temperature of 120° C., the polyester adhesive is formed into a polyester layer having a thickness of 3 μm.

Differences between Examples 1 to 3 reside in that the polyolefin pellet is melted and mixed with different amounts of the modifier, such that laminating film pellets (first polyolefin materials) with different acid values are produced. The acid values of the laminating film pellets (first polyolefin materials) in Examples 1 to 3 are listed in Table 1.

### Comparative Example 1

Comparative Example 1 is operated in a manner similar to that of Examples 1 to 3. Their difference resides in that the first polyolefin material in Comparative Example 1 does not include a modified group that contains maleic anhydride.

The types and acid values of the first polyolefin materials, component contents of the middle film, and the type of the second polyolefin material in Examples 1 to 3 and Comparative Example 1 are listed in Table 1. Test results are listed in Table 2. After Examples 1 to 3 and Comparative Example 1 are each manufactured into the aluminum plastic film, the aluminum plastic film is cut into a sample of 1.5 cm×10 cm, and an initial electrolyte-resistant adhesive strength of the sample is measured. Then, the sample is immersed in an electrolyte at 85° C. for 24 hours. After being taken out and dried, the sample is measured to obtain its electrolyte-resistant adhesive strength.

TABLE 1

| | | | | | Comparative |
|---|---|---|---|---|---|
| | | Example 1 | Example 2 | Example 3 | Example 1 |
| Laminating | Type of first polyolefin | Propylene | Propylene | Propylene | Propylene |
| film | material | random | random | random | random |
| | | copolymer | copolymer | copolymer | copolymer |
| | Content of first polyolefin | 100 | 100 | 100 | 100 |
| | material in laminating film | | | | |
| | (wt %) | | | | |
| | Acid value of first | 3.0 | 7.0 | 10.0 | 0.0 |
| | polyolefin material | | | | |
| | (mgKOH/g) | | | | |
| Middle | Content of propylene | 60 | 60 | 60 | 60 |
| film | block copolymer | | | | |
| | (phr) | | | | |
| | Content of ethylene | 30 | 30 | 30 | 30 |
| | elastomer | | | | |
| | (phr) | | | | |
| | Content of propylene | 10 | 10 | 10 | 10 |
| | random copolymer | | | | |
| | (phr) | | | | |
| | Content of slip agent | 0.1 | 0.1 | 0.1 | 0.1 |
| | (phr) | | | | |
| Heat- | Type of second polyolefin | Propylene | Propylene | Propylene | Propylene |
| sealed film | material | random | random | random | random |
| | | copolymer | copolymer | copolymer | copolymer |
| | Content of second | 100 | 100 | 100 | 100 |
| | polyolefin material in | | | | |
| | heat-sealed film | | | | |
| | (wt %) | | | | |

TABLE 2

| | | Exam- | Exam- | Exam- | Comparative |
|---|---|---|---|---|---|
| (N/15 mm) | | ple 1 | ple 2 | ple 3 | Example 1 |
| Adhesive | Initial | 14.1 | 15.6 | 14.8 | 2.5 |
| strength of | Immersed in | 12.0 | 13.0 | 12.7 | 2.0 |
| aluminum | electrolyte at | | | | |
| plastic film | 85° C. for 24 | | | | |
| | hours | | | | |

As can be observed from the content in Table 1 and Table 2, compared with Comparative Example 1, an effect of improving the electrolyte-resistant adhesive strength of the aluminum plastic film can be achieved by Examples 1 to 3 due to their use of the first polyolefin material having a modified group. Specifically, when the acid value of the first polyolefin material is controlled between 0.1 mgKOH/g and 10 mgKOH/g, the aluminum plastic film in the present disclosure has a good electrolyte-resistant adhesive strength (greater than 12 N/15 mm) Even after being exposed in a high temperature environment and being in contact with the electrolyte for a long time, such an aluminum plastic film can still have a good electrolyte-resistant adhesive strength (greater than 11 N/15 mm) Preferably, the electrolyte-resistant adhesive strength of the aluminum plastic film in the present disclosure ranges from 13 N/15 mm to 17 N/15 mm After immersion in the electrolyte at 85° C. for 24 hours, the electrolyte-resistant adhesive strength of the aluminum plastic film ranges from 12 N/15 mm to 15 N/15 mm.

### Beneficial Effects of the Embodiments

In conclusion, in the polyolefin film for the aluminum plastic film and the aluminum plastic film structure provided by the present disclosure, by virtue of “the first polyolefin material having a modified group, and a structure of the modified group containing maleic anhydride” and “a material forming the middle film including: 50 phr to 90 phr of a propylene block copolymer, 5 phr to 30 phr of an ethylene elastomer, and 5 phr to 20 phr of a propylene random copolymer,” the electrolyte-resistant adhesive strength of the aluminum plastic film can be improved.

Further, a special polyolefin film is used in the present disclosure, and the components in each layer of the polyolefin film (especially the components of the laminating film and the middle film) are controlled, so as to achieve the effect of improving the electrolyte-resistant adhesive strength of the aluminum plastic film. The material forming the laminating film has a modified group that contains a maleic anhydride structure, so that the polyolefin film can be thermally laminated to the aluminum foil at a low temperature, and can have a good electrolyte-resistant adhesive strength. By adjusting the proportions of the components in the material forming the middle film, the middle film can have good bonding with the laminating film and the heat-sealed film, and can also have a good electrolyte-resistant adhesive strength.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polyolefin film for an aluminum plastic film, comprising:
a laminating film, wherein a material forming the laminating film is a first polyolefin material, the first polyolefin material has a modified group, a structure of the modified group contains maleic anhydride, and a lamination temperature of the laminating film ranges from 70° C. to 100° C.;
a middle film disposed on the laminating film, wherein a material forming the middle film includes: 50 phr to 90 phr of a propylene block copolymer, 5 phr to 30 phr of an ethylene elastomer, and 5 phr to 20 phr of a propylene random copolymer; and
a heat-sealed film disposed on the middle film.

2. The polyolefin film according to claim 1, wherein an acid value of the first polyolefin material ranges from 0.1 mgKOH/g to 10 mgKOH/g.

3. The polyolefin film according to claim 1, wherein the modified group is formed from maleic anhydride, methyltetrahydrophthalic anhydride, 3,4,5,6-tetrahydrophthalic anhydride, tetrahydrophthalic anhydride, methylhexahydrophthalic anhydride, methyl nadic anhydride or 2,3-naphthalenedicarboxylic anhydride.

4. The polyolefin film according to claim 1, wherein the first polyolefin material is a random copolymer polymerized from a propylene monomer; wherein, based on a total weight of the first polyolefin material being 100 wt %, a proportion of the propylene monomer is greater than 50 wt %.

5. The polyolefin film according to claim 1, wherein the first polyolefin material is a random copolymer polymerized from an ethylene monomer, a propylene monomer, and a butylene monomer.

6. The polyolefin film according to claim 1, wherein a weight average molecular weight of the first polyolefin material ranges from 100,000 g/mol to 200,000 g/mol.

7. The polyolefin film according to claim 1, wherein the material forming the middle film has a melt index of from 0.5 g/10 min to 10 g/10 min when measured under conditions of 230° C. and a load of 2.16 kg.

8. The polyolefin film according to claim 1, wherein, based on a total weight of the propylene block copolymer being 100 wt %, a content of ethylene-propylene rubber blocks in the propylene block copolymer ranges from 18 wt % to 30 wt %.

9. The polyolefin film according to claim 1, wherein, based on a total weight of the ethylene elastomer being 100 wt %, a content of ethylene in the ethylene elastomer ranges from 30 wt % to 50 wt %.

10. The polyolefin film according to claim 9, wherein the ethylene elastomer is an ethylene/propylene elastomer, an ethylene/butylene elastomer or an ethylene/octylene elastomer.

11. The polyolefin film according to claim 1, wherein the propylene random copolymer is polymerized from a propylene monomer; wherein, based on a total weight of the propylene random copolymer being 100 wt %, a proportion of the propylene monomer is greater than 50 wt %.

12. The polyolefin film according to claim 1, wherein the propylene random copolymer is a random copolymer polymerized from an ethylene monomer, a propylene monomer, and a butylene monomer.

13. The polyolefin film according to claim 1, wherein a material forming the heat-sealed film is a second polyolefin material, and the second polyolefin material includes a random copolymer polymerized from an ethylene monomer and a propylene monomer; wherein, based on a total weight of the random copolymer in the second polyolefin material being 100 wt %, a proportion of the ethylene monomer ranges from 0.2 wt % to 2 wt %.

14. The polyolefin film according to claim 13, wherein the second polyolefin material further includes a propylene homopolymer, and an added amount of the propylene homopolymer ranges from 5 phr to 20 phr relative to 100 phr of the second polyolefin material.

15. The polyolefin film according to claim 13, wherein the second polyolefin material has a melt index of from 3 g/10 min to 10 g/10 min when measured under conditions of 230° C. and a load of 2.16 kg.

16. The polyolefin film according to claim 1, wherein the laminating film, the middle film, and the heat-sealed film are integrally formed by co-extrusion.

17. The polyolefin film according to claim 1, wherein, based on a total thickness of the polyolefin film being 100%, a thickness of the laminating film ranges from 10% to 15%, a thickness of the middle film ranges from 75% to 80%, and a thickness of the heat-sealed film ranges from 10% to 15%.

18. An aluminum plastic film structure, comprising:
an aluminum foil;
the polyolefin film as claimed in claim 1, wherein the polyolefin film is disposed on one surface of the aluminum foil through the laminating film; and
an outer film disposed on another surface of the aluminum foil;
wherein an electrolyte-resistant adhesive strength between the aluminum foil and the polyolefin film is greater than 14 N/15 mm; wherein, after immersion in an electrolyte at 85° C. for 24 hours, the electrolyte-resistant adhesive strength between the polyolefin film and the aluminum foil is greater than 11 N/15 mm.
